(19) United States
(12) Patent Application Publication
(10) Pub. No.: US 2017/0349698 A1
(43) Pub. Date: Dec. 7, 2017

(54) HYDROCARBON-CONTAINING POLYMERS WITH TWO ALKOXYSILANE END GROUPS

(71) Applicant: BOSTIK SA, La Plaine St Denis (FR)

(72) Inventors: Guillaume MICHAUD, Compiegne (FR); Frederic SIMON, Pont L'Eveque (FR); Stephane FOUQUAY, Mont Saint-Aignan (FR); Abdou Khadri DIALLO, Thorigne-Fouillard (FR); Sophie GUILLAUME, Vitre (FR); Jean-Francois CARPENTIER, Acigne (FR)

(73) Assignee: BOSTIK SA, La Plaine St Denis (FR)

(21) Appl. No.: 15/541,600

(22) PCT Filed: Jan. 7, 2016
(86) PCT No.: PCT/FR2016/050023

§ 371 Date: Jul. 5, 2017

(30) Foreign Application Priority Data
Jan. 8, 2015 (FR) 1550160

(51) Int. Cl. C08G 61/08; C09J 5/00; C09J 165/00

(52) U.S. Cl. CPC C08G 61/08; C09J 165/00; C09J 5/00; C08G 2261/3323; C08G 2261/1644; C08G 2261/135; C08G 2261/12; C08G 2261/76; C08G 2261/3324

(57) ABSTRACT

The invention relates to a hydrocarbon polymer containing two alcoxysilane end groups having the following Formula (I). The invention also relates to a method for preparing said polymer, to an adhesive composition containing said polymer, and to the use of said adhesive composition.

A subject of the present invention is hydrocarbon-containing polymers comprising two alkoxysilane end groups, the preparation thereof and the use thereof.

Modified silane polymers (MS polymers) are known in the field of adhesives. They are used for assembling a wide variety of objects (or substrates) by bonding. Thus, the MS polymer-based compositions are applied, in combination with a catalyst, in the form of an adhesive layer, onto at least one of two surfaces belonging to two substrates to be assembled and intended to be brought into contact with each other in order to assemble them. The MS polymer reacts by cross-linking with water from the ambient environment and/or water provided by the substrates, which leads to the formation of a cohesive adhesive bond ensuring the strength of the assembly of these two substrates. This adhesive bond is mainly constituted by the cross-linked MS polymer in a three-dimensional network formed by the polymer chains linked to each other by siloxane-type bonds. The cross-linking can take place before or after the two substrates are brought into contact, and the application, if appropriate, of pressure at their tangency surface.

However, the MS polymers most often have to be utilized in the form of adhesive compositions comprising other constituents, such as for example tackifying resins, one or more additives with a reinforcing effect such as for example at least one mineral filler, or one or more additives aimed at improving the setting time (i.e. the time after which the cross-linking can be considered as completed) or other characteristics such as the rheology or mechanical performances (elongation, modulus etc.).

Patent application CA 2242060 describes the possibility of using a composition of the polymer-based adhesive-seal type containing at least one cycloolefin, a catalyst for chain-opening metathesis polymerization, a filler and a compound which comprises only one silane function.

It is known to prepare telechelic polymers comprising an alkoxysilane end group and a vinyl end group, by means of a transfer agent containing a single silane function.

Thus, patent application EP 2468783 describes the preparation of a polyurethane with polyurethane-polyether and polyurethane-polyester blocks with at least two polyurethane-polyester end groups linked to an alkoxysilane end group, as well as an adhesive composition comprising this polyurethane and a cross-linking catalyst. The silane end group originates from an isocyanatosilane which comprises only one silane function.

It is also known to prepare telechelic polymers comprising a repeat unit originating from a cyclic monomer such as for example norbornene.

Thus, patent application WO 01/04173 describes the catalytic copolymerization by ring-opening metathesis of branched cycloolefins comprising the same cycloolefin. Said cycloolefin is preferably norbornene.

Moreover, patent application WO 2011/038057 describes the ring-opening metathesis polymerization of norbornene and optionally of 7-oxanorbornene dicarboxylic anhydrides.

Finally, patent application GB 2238791 describes a process for the polymerization of 7-oxanorbornene by ring-opening metathesis polymerization.

The purpose of the present invention is to propose novel polymers with two alkoxysilane end groups. These polymers can lead, after cross-linking, to the formation of an adhesive bond having improved mechanical properties and in particular greater cohesion compared with those of the state of the art.

Thus, the present invention relates to a hydrocarbon-containing polymer comprising two alkoxysilane end groups, said hydrocarbon-containing polymer being of formula (1) below:

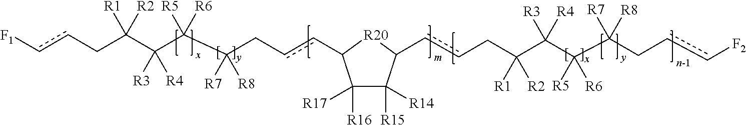

in which F₁ is (R′O)_{3-z}R_{z}Si—(CH₂)ₚ₁— and F₂ is —(CH₂)_{q1}—SiR_{z}(OR′)_{3-z}; or F₁ is (R′O)_{3-z}R_{z}Si—R″—OOC—(CH₂)ₚ₂— and F₂ is —(CH₂)_{q2}—COO—R″—SiR_{z}(OR′)_{3-z}; where z is an integer equal to 0, 1, 2 or 3; p1 and q1 are independently an integer equal to 1, 2 or 3; p2 and q2 are independently an integer equal to 0, 1, 2 or 3; the R and R′ groups are independently an alkyl group, preferably linear, comprising from 1 to 4, preferably from 1 to 2, carbon atoms; the R″ group is an alkylene group, preferably linear, comprising from 1 to 4 carbon atoms; and in which:
each carbon-carbon bond of the chain denoted [symbol] is a double bond or a single bond, in accordance with the valency rules of organic chemistry;
the R1, R2, R3, R4, R5, R6, R7 and R8 groups are independently a hydrogen, a halogen atom, an alkyl group, a heteroalkyl group, an alkenyl group, an alkoxycarbonyl group or a heteroalkoxycarbonyl group, at least one of the R1 to R8 groups being able to form part of the same ring or heterocycle, saturated or unsaturated, with at least one other of the R1 to R8 groups according to the valency rules of organic chemistry and at least one of the (R1,R2), (R3,R4), (R5,R6) and (R7,R8) pairs being able to be an oxo group;
x and y are integers independently comprised in a range from 0 to 5, preferably from 0 to 2, even more preferably x is equal to 1 and y is equal to 1, the sum of x+y being preferably comprised in a range from 0 to 4 and even more preferably from 0 to 2;
the R14, R15, R16 and R17 groups are independently a hydrogen, a halogen atom, an alkyl group, a heteroalkyl group, an alkenyl group, an alkoxycarbonyl group or a heteroalkoxycarbonyl group, at least one of the R14 to R17 groups being able to form part of the same ring or heterocycle, saturated or unsaturated, with at least one other of the R14 to R17 groups, according to the valency rules of organic chemistry;
the R20 group is CH₂, O, S, NR₀ or C(═O), R₀ being an alkyl group or an alkenyl group, preferably linear, comprising from 1 to 22, preferably from 1 to 14, carbon atoms; and
   n is an integer greater than or equal to 2 and m is an integer strictly greater than 0, the molar ratio m:n being comprised between 0 and 0.5, preferably between 0.25 and 0.5; n and m being moreover such that the number-average molecular weight Mn of the hydrocarbon-containing polymer of formula (1) is comprised in a range from 400 to 50,000 g/mol, preferably from 600 to 20,000 g/mol, and the polydispersity index (PDI) of the hydrocarbon-containing polymer of formula (1) is comprised in a range from 1.0 to 3.0, preferably from 1.0 to 2.0, even more preferably from 1.45 and 1.85.

Of course, all the formulae are given here in accordance with the valency rules of organic chemistry.

The main chain of the polymer of formula (1) thus comprises two types of repeat units, a first type of repeat unit repeated n times and a second type of repeat unit repeated m times.

By “m:n comprised between 0 and 0.5” is thus meant that m:n is in a range from 0 to 0.5, excluded limits.

As it appears above, the end groups F1 and F2 are generally substantially symmetrical with respect to the main chain, i.e. they substantially correspond to each other, with the exception of the indices p1 and p2, and q1 and q2.

By “alkyl group” is meant a saturated monovalent hydrocarbon-containing compound, linear or branched, cyclic, acyclic, heterocyclic or polycyclic, and, unless otherwise indicated, generally comprising from 1 to 22 carbon atoms. Such an alkyl group most often comprises from 1 to 14, preferably from 1 to 8 carbon atoms. By “heteroalkyl group” is meant according to the invention an alkyl group in which at least one of the carbon atoms is replaced by a heteroatom selected from the group formed by O and S.

By “alkylene group” is meant a saturated divalent hydrocarbon-containing compound, linear or branched, cyclic, acyclic, heterocyclic or polycyclic, and, unless otherwise indicated, generally comprising from 1 to 22 carbon atoms. Such an alkylene group most often comprises from 1 to 14, preferably from 1 to 8, carbon atoms.

By “alkenyl group” is meant an unsaturated hydrocarbon-containing compound (i.e. comprising at least one double bond), linear or branched, cyclic, acyclic, heterocyclic or polycyclic, and generally comprising from 1 to 22 carbon atoms. Such an alkenyl group most often comprises from 1 to 14, preferably from 1 to 8 carbon atoms.

By “alkoxycarbonyl group” is meant a (monovalent) alkyl group, linear or branched, saturated or partially unsaturated, comprising from 1 to 22, preferably from 1 to 14, carbon atoms, as well as a —COO— divalent group. By “heteroalkoxycarbonyl group” is meant according to the invention an alkoxycarbonyl group in which at least one of the carbon atoms is replaced by a heteroatom selected from the group formed by O and S.

By “halogen atom” is meant an iodine, chlorine, bromine or fluorine atom, preferably chlorine.

By “heterocycle” is meant a hydrocarbon-containing ring which can comprise an atom other than carbon in the ring chain, such as for example oxygen, sulphur or nitrogen.

By “alkoxysilane group” is meant a group comprising an alkyl group, linear or branched, saturated or partially unsaturated, comprising from one to four, preferably from one to two carbon atoms and, moreover, an —Si—O— divalent group.

By “at least one of the R1 to R8 groups being able to form part of the same ring or heterocycle, saturated or unsaturated, with at least one other of the R1 to R8 groups, according to the valency rules of organic chemistry” is meant according to the invention, that these two groups, whether or not they are borne by the same carbon, are linked together by a hydrocarbon-containing chain optionally comprising at least one heteroatom such as S or O. Thus, for example, such a ring is constituted by R1-O—R8. This is also applicable to the R14 to R17 groups.

By “(R1,R2) pair being able to be an oxo group” is meant according to the invention that the (R1,R2) pair is such that

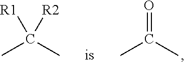

where C is the carbon which bears the two groups forming the (R1,R2) pair. This is also applicable to the (R3,R4), (R5,R6) and (R7,R8) pairs.

By “end group” is meant a group situated at the end of the chain (or end) of the polymer. The polymer according to the invention comprises a main chain, i.e. a longer chain, both ends of which are the end groups of the polymer according to the invention.

The polydispersity index PDI (or dispersity [symbol] _{M}) is defined as the ratio Mw/Mn, i.e. the ratio of the weight-average molecular weight to the number-average molecular weight of the polymer.

The two average molecular weights Mn and Mw are measured according to the invention by size exclusion chromatography (SEC), usually with PEG (PolyEthyleneGlycol) or PS (PolyStyrene) calibration, preferably PS.

Preferably, the R5 to R8 groups are each a hydrogen.

Particularly preferably, x is equal to 1 and y is equal to 1.

If z=0, then there is no R group in the formula (R′O)_{3-z}R_{z}Si— which becomes (R′O)₃Si—.

If p2=0 or q2=0, then there is no (CH2) group in the formula —(CH₂)ₚ₂— which becomes — or in the formula —(CH₂)_{q2}— which becomes —.

When the index x or y which is applied to a set of two brackets is equal to zero, this means that there is no group between the brackets to which this index is applied. Thus,

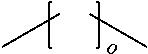

means -, and

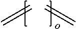

means =.

According to an embodiment of the invention all the [symbol] bonds of formula (1) are carbon-carbon double bonds, and formula (1) then becomes formula (1′) below:

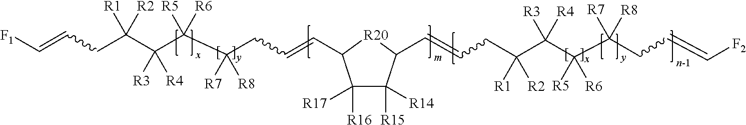

in which x, y, m, n, F₁, F₂, R1, R2, R3, R4, R5, R6, R7, R8, R14, R15, R16, R17 and R20 have the meanings given previously and the [symbol] bond is a geometrically oriented bond on either side with respect to the double bond (cis or trans).

According to another embodiment of the invention all the [symbol] bonds of formula (1) are carbon-carbon single bonds, and formula (1) then becomes formula (1H) which is described below.

Each of the double bonds of the polymer of formula (1′) is geometrically oriented cis or trans, and is preferably of cis orientation. The geometrical isomers of the polymer of formula (1′) are generally present in variable proportions, most often with a majority of cis (Z)-cis (Z)-cis (Z)-cis (Z). It is preferred according to the invention to have mixtures the double bonds of which are predominantly oriented cis (Z) and preferably all oriented cis (Z). It is also possible according to the invention to obtain a single one of the geometric isomers, according to the reaction conditions and in particular according to the nature of the catalyst used.

The invention also relates to a polymer of formula (1H) below:

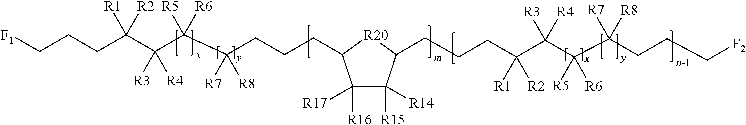

in which x, y, m, n, F₁, F₂, R1, R2, R3, R4, R5, R6, R7, R8, R14, R15, R16, R17 and R20 have the meanings given previously.

Formula (1H) illustrates the case where the main chain of the polymer of formula (1) is saturated, i.e. comprises only saturated bonds.

The polymer of formula (1H) can for example originate from the hydrogenation of the unsaturated polymer of formula (1′).

According to a first embodiment, F1 is (R′O)_{3-z}R_{z}Si—(CH₂)ₚ₁— and F2 is —(CH₂)_{q1}—SiR_{z}(OR′)_{3-z}, with p1=1 or q1=1, preferably p1=q1=1. In this case, preferably, R′ is a methyl, z=0, p1=1 and q1=1.

According to a second embodiment (called “diester route”), F1 is (R′O)_{3-z}R_{z}Si—R″—OOC—(CH₂)ₚ₂— and F₂ is —(CH₂)_{q2}—COO—R″—SiR_{z}(OR′)_{3-z}, with p2=0 or q2=0, preferably p2=q2=0. In this case, preferably, R′ is a methyl, R″ is the —(CH₂)₃— group, z=0, p2=0 and q2=0.

The polymers of formulae (1), (1′) and (1H) according to the invention are particularly homogeneous and temperature-stable. They are preferably packaged and stored away from moisture.

The polymers of formulae (1), (1′) and (1H) according to the invention can form, after cross-linking with water from the ambient environment and/or water provided by at least one substrate, generally in atmospheric humidity, for example in the case of a relative humidity of the air (also called degree of hygrometry) usually comprised in a range from 25 to 65%, and in the presence of an appropriate cross-linking catalyst, an adhesive bond which has strong cohesion values, in particular greater than 3 MPa. Such cohesion values allow use as an adhesive, for example as a seal on a usual support (concrete, glass, marble) in the construction industry, or also for the bonding of glazing in the motor and shipbuilding industry.

This ability of the polymers according to the invention to cross-link in the present of moisture is thus particularly advantageous.

Furthermore, the non-cross-linked polymers according to the invention are polymers that are solid or liquid at ambient temperature (i.e. approximately 20° C.). Preferably, these are liquid polymers having a viscosity at 23° C. ranging from 1 to 500,000 mPa·s, preferably from 1 to 150,000 mPa·s and even more preferably from 1 to 50,000 mPa·s. When the molar ratio m:n is comprised between 0.25 and 0.5 and/or at least one of the R1 to R8 and/or R14 to R17 groups comprises an alkyl group, the non-cross-linked polymers according to the invention are preferably liquid polymers having a viscosity at 23° C. ranging from 1 to 500,000 mPa·s.

When the non-cross-linked polymer according to the invention is solid at ambient temperature, it is generally thermoplastic (in anhydrous medium) i.e. deformable and hot-melt (i.e. at a temperature greater than ambient temperature). It can thus be used as hot-melt adhesive and applied hot onto the interface of substrates to be assembled at their tangency surface. By solidifying at ambient temperature, an adhesive bond firmly fixing the substrates is thus immediately created, then giving the adhesive advantageous reduced setting-time properties.

When the non-cross-linked polymer according to the invention is a liquid that is more or less viscous at ambient temperature, the adhesive composition which comprises it can comprise at least one additional constituent such as a tackifying resin or a filler.

The invention also relates to a process for the preparation of at least one hydrocarbon-containing polymer comprising two alkoxysilane end groups according to the invention, said process comprising at least one ring-opening metathesis polymerization step, in the presence of:
at least one metathesis catalyst, preferably a catalyst comprising ruthenium, even more preferably a Grubbs' catalyst;
at least one alkoxysilane difunctional chain transfer agent (CTA) of formula (C) below:

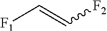

in which the bond [symbol] is a geometrically oriented bond on either side with respect to the double bond (cis or trans); F₁ is (R′O)_{3-z}R_{z}Si—(CH₂)ₚ₁— and F₂ is —(CH₂)_{q1}—SiR_{z}(OR′)_{3-z}; or F₁ is (R′O)_{3-z}R_{z}Si—R″—OOC—(CH₂)ₚ₂— and F₂ is —(CH₂)_{q2}—COO—R″—SiR_{z}(OR′)_{3-z}; where z is an integer equal to 0, 1, 2 or 3; p1 and q1 are independently an integer equal to 1, 2 or 3; p2 and q2 are independently an integer equal to 0, 1, 2 or 3; the R and R′ groups are independently an alkyl group, preferably linear, comprising from 1 to 4, preferably from 1 to 2, carbon atoms; the R″ group is an alkylene group, preferably linear, comprising from 1 to 4 carbon atoms;
at least one compound of formula (A) below:

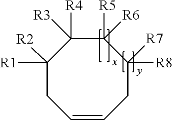

in which:
the R1, R2, R3, R4, R5, R6, R7 and R8 groups are independently a hydrogen, a halogen atom, an alkyl group, a heteroalkyl group, an alkenyl group, an alkoxycarbonyl group or a heteroalkoxycarbonyl group, at least one of the R1 to R8 groups being able to form part of the same ring or heterocycle, saturated or unsaturated, with at least one other of the R1 to R8 groups according to the valency rules of organic chemistry and at least one of the (R1,R2), (R3,R4), (R5,R6) and (R7,R8) pairs being able to be an oxo group;
x and y are integers independently comprised in a range from 0 to 5, preferably from 0 to 2, even more preferably x is equal to 1 and y is equal to 1, the sum of x+y being preferably comprised in a range from 0 to 4 and even more preferably from 0 to 2;
   and
      at least one compound of formula (B):

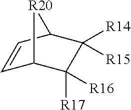

in which
the R14, R15, R16 and R17 groups are independently a hydrogen, a halogen atom, an alkyl group, a heteroalkyl group, an alkenyl group, an alkoxycarbonyl group or a heteroalkoxycarbonyl group, at least one of the R14 to R17 groups being able to form part of the same ring or heterocycle, saturated or unsaturated, with at least one other of the R14 to R17 groups, according to the valency rules of organic chemistry; and
the R20 group is CH₂, O, S, NR₀ or C(═O), R₀ being an alkyl group or an alkenyl group, preferably linear, comprising from 1 to 22, preferably from 1 to 14, carbon atoms;
   for a reaction time ranging from 2 to 24 hours and at a temperature comprised in a range from 20 to 60° C.

The time and temperature for a given reaction generally depend on the reaction conditions and in particular the level of catalytic load. A person skilled in the art is able to adapt them depending on the circumstances.

The molar ratio of the CTA to the sum of the compounds of formulae (A) and (B) is comprised in a range from 0.01 to 0.10, preferably from 0.05 to 0.10.

The compounds of formula (A) generally comprise from 6 to 30, preferably from 6 to 22 carbon atoms.

The compounds of formula (B) generally comprise from 6 to 30, preferably from 6 to 22 carbon atoms.

In a preferred embodiment of the invention, x=y=1.

Ring-opening metathesis polymerization is a reaction well known to a person skilled in the art, which is implemented here in the presence of a particular CTA compound of formula (C) comprising two silane functions.

The cyclic compounds of formula (A) are preferably, according to the invention, selected from the group formed by cycloheptene, cyclooctene, cyclononene, cyclodecene, cycloundecene, cyclododecene, 1,5-cyclooctadiene, cyclononadiene and 1,5,9-cyclodecatriene.

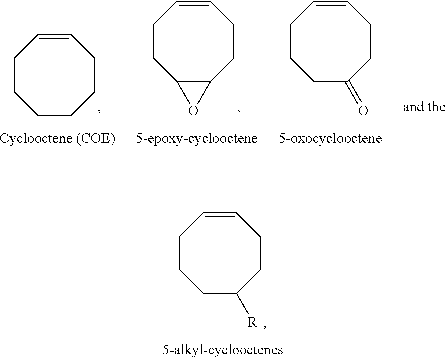

where R is an alkyl group comprising from 1 to 22, preferably 1 à 14, carbon atoms, are preferred according to the invention, cyclooctene being quite particularly preferred. For example, R is an n-hexyl group.

The cyclic compounds of formula (B) are preferably, according to the invention, selected from the group formed by norbornene, norbornadiene, dicyclopentadiene, 7-oxanorbornene and 7-oxanorbornadiene which are respectively of the following formulae:

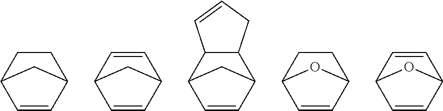

Norbornene and 7-oxanorbornene are particularly preferred.
The cyclic compounds of formula (B) can also be selected from the group formed by the compounds of formulae:

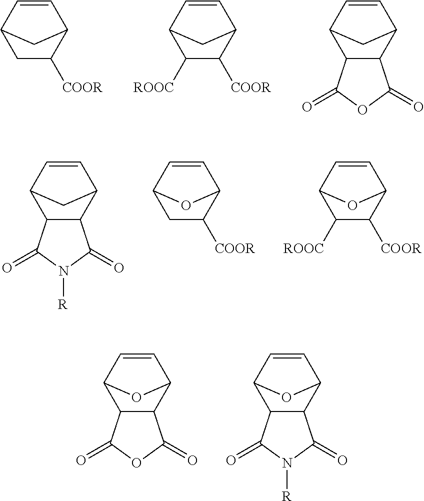

where R is an alkyl group comprising from 1 to 22, preferably 1 à 14, carbon atoms. For example, R is an n-hexyl group.

The cyclic compounds of formula (B) can also be selected from the group formed by the addition products (or adducts) originating from the Diels-Alder reaction using cyclopentadiene or furan as starting product, as well as the compounds derived from norbornene such as the branched norbornenes as described in WO 2001/04173 (such as: norbornene isobornyl carboxylate, norbornene phenyl carboxylate, norbornene ethylhexyl carboxylate, norbornene phenoxyethyl carboxylate and alkyl norbornene dicarboxymide, the alkyl most often comprising from 3 to 8 carbon atoms) and the branched norbornenes as described in WO 2011/038057 (norbornene dicarboxylic anhydrides and optionally 7-oxanorbornene dicarboxylic anhydrides).

According to a first embodiment, the CTA is of the following formula (C1):

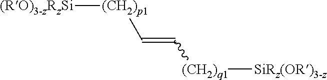

in which z, R, R′, p1, q1 and [symbol] have the meanings given previously.

In this case, preferably, R′ is a methyl, z=0, p1=1 and q1=1.

This compound can be manufactured according to the procedure described in WO 01/83097 by cross metathesis of H₂C═CH—(CH₂)ₚ—SiR_{z}(OR′)_{3-z} mono-unsaturated compounds.

According to a second embodiment (called “diester route”), the CTA has the following formula (C2):

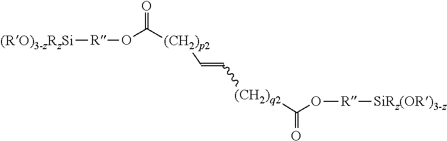

in which z, R, R′, R″, p2, q2 and [symbol] have the meanings given previously.

In this case, preferably, R′ is a methyl, R″ is the —(CH₂)₃— group, z=0, p2=0 and q2=0.

This compound can be manufactured by esterification of an acid dichloride of the ClC(═O)(CH₂)ₚ₂CH═CH(CH₂)_{q2}C(═O)Cl type (itself prepared from the corresponding commercial carboxylic diacid) with two moles of hydroxysilanes.

According to the invention, the CTA can be selected from the group formed by the compounds of formula (C1) and the compounds of formula (C2).

Preferably, the CTA is selected from the group formed by bis(propyltrimethoxysilyl)fumarate and trans-1,4-bis(trimethoxysilyl)but-2-ene.

The step of polymerization by “Ring Opening Metathesis Polymerization” (ROMP) is most often implemented in the presence of at least one solvent, generally selected from the group formed by the aqueous or organic solvents typically used in the polymerization reactions and which are inert under the polymerization conditions, such as aromatic hydrocarbons, chorine-containing hydrocarbons, ethers, aliphatic hydrocarbons, alcohols, water or mixtures thereof. A preferred solvent is selected from the group formed by benzene, toluene, para-xylene, methylene chloride, dichloroethane, dichlorobenzene, chlorobenzene, tetrahydrofuran, diethyl ether, pentane, hexane, heptane, methanol, ethanol, water or mixtures thereof. Even more preferably, the solvent is selected from the group formed by benzene, toluene, para-xylene, methylene chloride, dichloroethane, dichlorobenzene, chlorobenzene, tetrahydrofuran, diethyl ether, pentane, hexane, heptane, methanol, ethanol, or mixtures thereof. Even more particularly preferably, the solvent is toluene, heptane, or a mixture of toluene and methylene chloride. The solubility of the polymer formed during the polymerization reaction generally and mainly depends on the selection of the solvent and the molecular weight of the polymer obtained. It is also possible for the reaction to be implemented without solvent.

The metathesis catalyst, such as for example a Grubbs' catalyst, is generally a commercial product.

The metathesis catalyst is most often a transition metal catalyst, including in particular a catalyst comprising ruthenium, most often in the form of ruthenium complex(es) such as a ruthenium-carbene complex. It is thus possible, particularly preferably, to use the Grubbs' catalysts. By Grubbs' catalyst is generally meant, according to the invention, a 1st or 2nd generation Grubbs' catalyst, but also any other Grubbs-type catalyst (of the ruthenium-carbene type) accessible to a person skilled in the art, such as for example the substituted Grubbs' catalysts described in the U.S. Pat. No. 5,849,851.

A 1st generation Grubbs' catalyst is generally of formula (8):

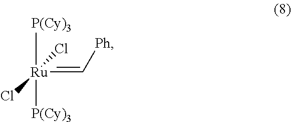

in which Ph is phenyl and Cy is cyclohexyl.

The P(Cy)₃ group is a tricyclohexylphosphine group.

The IUPAC name of this compound is: benzylidene-bis(tricyclohexylphosphine) dichlororuthenium (CAS number 172222-30-9).

A 2nd generation Grubbs' catalyst (or G2) is generally of formula (9):

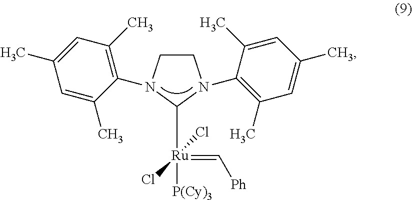

in which Ph is phenyl and Cy is cyclohexyl.

The IUPAC name of the second generation of this catalyst is: benzylidene[1,3-bis(2,4,6-trimethylphenyl)-2-imidazolidinylidene]dichloro(tricyclohexylphosphine) ruthenium (CAS number 246047-72-3).

The process for the preparation of a hydrocarbon-containing polymer according to the invention can moreover comprise at least one additional step of hydrogenation of double bonds.

This step is generally implemented by catalytic hydrogenation, most often under hydrogen pressure and in the presence of a hydrogenation catalyst such as a carbon-supported palladium catalyst (Pd/C). More particularly, it makes it possible to form a compound of formula (1H) from an unsaturated compound of formula (1′).

The invention also relates to an adhesive composition comprising a polymer according to the invention and from 0.01 to 3% by weight, preferably from 0.1 to 1% by weight of a cross-linking catalyst, with respect to the weight of the adhesive composition. The polymer according to the invention is a polymer of formula (1), (1′) or (1H).

The cross-linking catalyst can be used in the composition according to the invention and can be any catalyst known to a person skilled in the art for silanol condensation. There may be mentioned as examples of such catalysts:
organic titanium derivatives such as titanium(IV) di(acetylacetonate)-diisopropylate (commercially available from Dupont under the name TYZOR® AA75);
organic aluminium derivatives such as aluminium chelate (commercially available from King Industries under the name K-KAT® 5218);
organic tin derivatives such as dibutyltin dilaurate (DBTL); and
amines, such as 1,8-DiazaBicyclo[5.4.0]Undec-7-ene (DBU) and 1,5-diazabicyclo[4.3.0]non-5-ene (DBN).

It is also possible to include in the composition according to the invention UV stabilizers such as amines or antioxidants.

The antioxidants can comprise primary antioxidents which trap free radicals and which are generally substituted phenols such as Irganox® 1010 from Ciba. The primary antioxidants can be used alone or in combination with other antioxidants such as phosphites such as Irgafos® 168 from Ciba.

According to a particularly preferred embodiment, the adhesive composition according to the invention is packaged in air-tight packaging prior to its end use, so as to protect it from ambient humidity. Such packaging can advantageously be formed by a multi-layer foil which typically comprises at least one layer of aluminium and/or at least one layer of high-density polyethylene. For example, the packaging is formed by a layer of polyethylene coated with an aluminium foil. Such packaging can in particular be in the form of a cylindrical cartridge.

The invention finally relates to a process for bonding by assembling two substrates comprising:
coating with an adhesive composition as defined previously, in liquid form, preferably in the form of a layer with a thickness comprised in a range from 0.3 to 5 mm, preferably from 1 to 3 mm, over at least one of the two surfaces which belong respectively to the two substrates to be assembled, and which are intended to be brought into contact with each other at a tangency surface; then
effectively bringing the two substrates into contact at their tangency surface.

The adhesive composition in liquid form is either the (naturally) liquid adhesive composition, or the molten adhesive composition. A person skilled in the art is able to proceed in such a way that the adhesive composition used is in liquid form at the time of use.

Of course, the coating and bringing into contact must be carried out within a compatible time interval, as it is well known to a person skilled in the art, i.e. before the adhesive layer applied to the substrate loses its ability to fix this substrate to another substrate by bonding. In general, the cross-linking of the polymer of the adhesive composition, in the presence of the catalyst and water from the ambient environment and/or water provided by at least one of the substrates, begins to be produced during the coating, then continues to be produced during the step of bringing the two substrates into contact. In practice, the water generally results from the relative humidity of the air.

Appropriate substrates are, for example, inorganic substrates such as glass, ceramics, concrete, metals or alloys, such as alloys of aluminium, steel, non-ferrous metals and galvanized metals); or organic substrates such as wood, plastics such as PVC, polycarbonate, PMMA, polyethylene, polypropylene, polyesters, epoxy resins; metal substrates and paint-coated composites (as in the motor industry).

The invention will be better understood in light of the following examples.

### EXAMPLES

The following examples illustrate the invention without, however, limiting its scope.

The synthesis reactions of the examples were carried out in two or three steps, with a cycloolefin synthesis step, a transfer agent (CTA) of formula (C) synthesis step and a step of ring-opening metathesis polymerization of the cycoolefin of formula (A) and of the compound of formula (B) in the presence of a Grubbs' catalyst and transfer agent.

General diagram 1 of the polymerization reactions implemented in the examples is given below, and will be explained case by case in the examples.

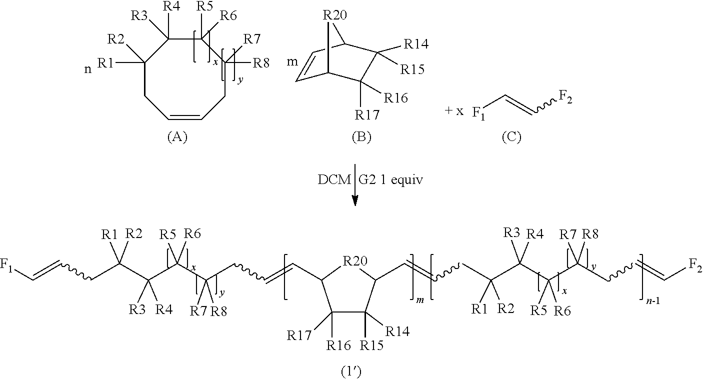

In which DCM is dichloromethane;
In which the [symbol] bond is a geometrically oriented bond on either side with respect to the double bond (cis or trans); the chain transfer agent CTA is of formula (C), the cycloolefins are of formulae (A) and (B), and G2 is the metathesis catalyst of formula (9):

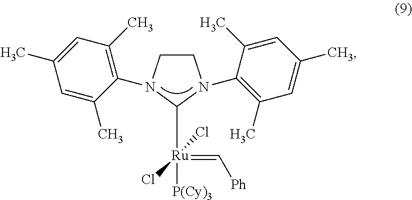

in which Ph is phenyl and Cy is cyclohexyl; and
In which the F1 and F2 groups are symmetrical and correspond respectively to the —COO(CH₂)₃Si(OCH₃)₃ group (case where CTA is bis(propyltrimethoxysilyl)fumarate) and to —CH₂—Si(OCH₃)₃ (case where the CTA is trans-1,4-bis(trimethoxysilyl)but-2-ene); n is the number of moles of cycloolefins of formula (A), m is the number of moles of cycloolefins of formula (B), x is the number of moles of CTA of formula (C).

The number of monomer units in the polymer is equal to n+m.

In each of Examples 1 and 2 described below, using diagram 1, the reaction lasts 24 hours at a temperature of 40° C.

All the polymerizations were carried out in a similar way. The only differences reside in the nature and the initial concentration of the chain transfer agent (CTA). The bis(propyltrimethoxysilyl)fumarate (CTA¹) and trans-1,4-bis(trimethoxysilyl)but-2-ene (CTA²) illustrating the invention, are used in Examples 1 and 2 and are of the following respective formulae:

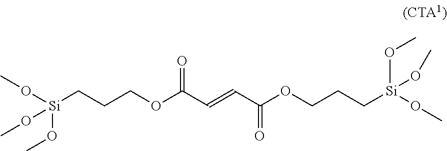

(which corresponds to the case where F₁ is (R′O)_{3-z}R_{z}Si—R″—OOC—(CH₂)ₚ₂— and F₂ is —(CH₂)_{q2}—COO—R″—SiR_{z}(OR′)_{3-z}, with R′ methyl, R″=—(CH₂)₃—, z=0, p2=0 and q2=0);

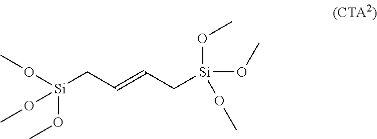

(which corresponds to the case where F₁ is (R′O)_{3-z}R_{z}Si—(CH₂)ₚ₁— and F₂ is —(CH₂)_{q1}—SiR_{z}(OR′)_{3-z}, with R′ methyl, z=0, p1=1 and q1=1).

### Examples 1 and 2: Polymerization of a Mixture of Cycloolefins of Formulae (A) and (B)

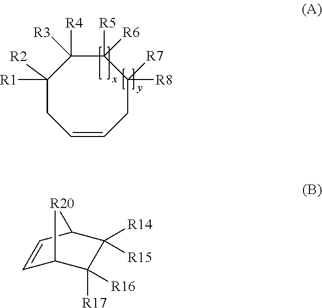

The polymerization process described below is such that the cycloolefins of formulae (A) and (B) are respectively as follows:

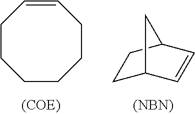

The cyclooctene (COE) of purity greater than 95% and the norbornene (NBN) of purity greater than 99% were commercial products from Sigma Aldrich. They were distilled over CaH₂ beforehand.

The raw materials, reagents and solvents used during these syntheses were commercial products from Sigma Aldrich.

The cycloolefins of formulae (A) and (B), respectively COE (5.4 mmol) and NBN (5.4 mmol) described above, and dry CH₂Cl₂ (5 mL) were placed in a 100-mL flask in which a magnetic stirrer coated with Teflon® was also placed. The flask and its contents were then placed under argon. The compound of formula CTA¹ or CTA² (1.08 mmol) was then introduced into the flask by syringe. The flask was then immersed in an oil bath at 40° C. then catalyst G2 (5.4 μmol) in solution in CH₂Cl₂ (2 mL) was immediately added by means of a cannula. The reaction mixture then became very viscous in two minutes. The viscosity then decreased slowly over the following 10 minutes. After 24 hours starting from the addition of the catalyst, the product present in the flask was extracted after the solvent was concentrated under vacuum. A product was then recovered after precipitation from methanol, filtration and drying at 20° C. under vacuum (Yield of at least 90% in each of the cases). ¹H/¹³C NMR analysis made it possible to demonstrate that the product was indeed a polymer having the expected formula.

All the polymers prepared in the examples were recovered as solid powder or as liquid according to the NBN/COE molar ratio, colourless, easily soluble in chloroform and insoluble in methanol.

The different tests of Examples 1 and 2 are summarized in Tables 1 and 2 and detailed below.

TABLE 1

| Test | | Conversion | Mn_{DRY} | |
|---|---|---|---|---|
| No. | [A]/[B]/[CTA¹]/[Ru] (mol/mol) | (%) | (g/mol) | PDI |
| 1 | 1,000/1,000/200/1 | 100 | 7900 | 1.60 |

Where CTA¹ = bis(propyltrimethoxysilyl)fumarate

TABLE 2

| Test | | Conversion | Mn_{DRY} | |
|---|---|---|---|---|
| No. | [A]/[B]/[CTA²/[Ru] (mol/mol) | (%) | (g/mol) | PDI |
| 2 | 1,000/1,000/200/1 | 100 | 7800 | 1.58 |

Where CTA² = trans-1,4-bis(trimethoxysilyl)but-2-ene

### Example 1: Synthesis of a Polymer Comprising Two Alkoxysilane End Groups Starting from Cyclooctene (COE), Norbornene (NBN) and CTA¹

The reaction was implemented according to diagram 2 below, in an m:n molar ratio equal to 0.3:

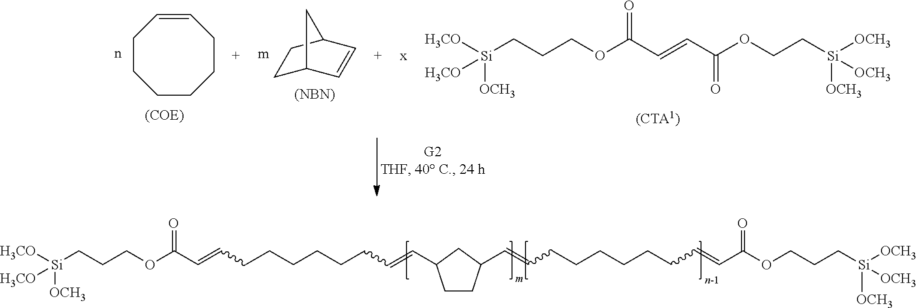

The polymer obtained was liquid at ambient temperature.

The NMR analyses of the polymer obtained for this test gave the following values, which confirmed the structure of the polymer:

¹H NMR (CDCl₃, 400 MHz, 298 K): repeat unit trans: 1.23 (12H*n), 1.72-1.89 (6H*n), 2.37 (2H*n trans), 5.31 (2H*n trans), cis:1.23 (12H*n), 1.72-1.89(6H*n), 2.72 (2H*n cis), 5.13 (2H*n cis), end group: 0.67 (4H, m, —CH₂—CH₂—Si—), 1.45 (4H, m, —CO—CH—CH—CH₂—CH₂—), 1.77 (4H, m, —O—CH₂—CH₂—CH₂—Si—), 2.19 (4H, m, —CO—CH—CH—CH₂—CH₂—), 3.57 (18H, s, —Si—O—CH₃), 4.09 (4H, t, —O—CH₂—CH₂—CH₂—Si—), 5.81 (2H, m, —CH═CH—COO), 6.94 (2H, m, —CH═CH—COO).

¹³C NMR (CDCl₃, 100 MHz, 298 K): repeat unit 29.17, 29.54, 29.78, 32.37, 33.10, 38.02, 38.67, 41.35, 42.77, 43.13, 43.52, 130.35, 134.89, end groups: 5.49 (—CH₂—CH₂—Si—), 22.24 (—O—CH₂—CH₂—CH₂—Si—), 50.69 (—Si—O—CH₃), 66.22 (—O—CH₂—CH₂—CH₂—Si—), 121.33 (—CH═CH—COO), 149.60 (—CH═CH—COO), 166.87 (—O—CO—).

### Example 2: Synthesis of a Polymer Comprising Two Alkoxysilane End Groups Starting from Cyclooctene (COE), Norbornene (NBN) and CTA²

The reaction was implemented according to diagram 3 below, in an m:n molar ratio equal to 0.3:

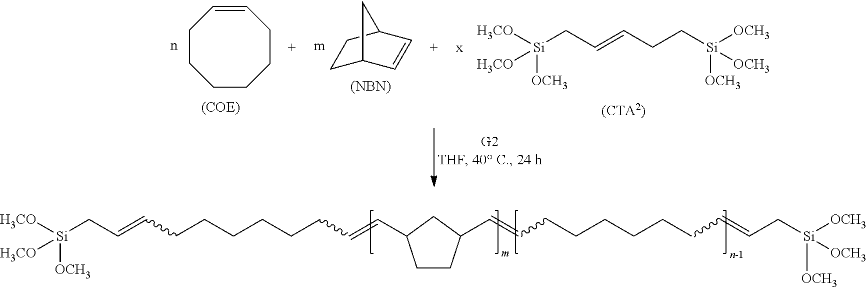

The polymer obtained was liquid at ambient temperature.

The NMR analyses of the polymer obtained for this test gave the following values, which confirmed the structure of the polymer:

¹H NMR (CDCl₃, 400 MHz, 298 K): repeat unit trans: 1.23 (12H*n), 1.72-1.89 (6H*n), 2.37 (2H*n trans), 5.31 (2H*n trans), cis:1.23 (12H*n), 1.72-1.89 (6H*n), 2.72 (2H*n cis), 5.13 (2H*n cis), end group: 1.63 (4H, m, —CH—CH₂—Si—), 3.57 (18H, s, —Si—O—CH₃).

¹³C NMR (CDCl₃, 298 K): repeat unit: 29.17, 29.54, 29.78, 32.37, 33.10, 38.02, 38.67, 41.35, 42.77, 43.13, 43.52, 130.35, 134.89, end groups: trans 15.04 (—CH—CH₂Si—), cis 10.92 (—CH—CH₂—Si—), 50.73 (—Si—O—CH₃), 122.61 (—Si—CH₂—CH═CH—), 131.39 (—Si—CH₂—CH═CH—CH₂—).

### Example 3: Synthesis of an Adhesive Composition from a Polymer Comprising Two Alkoxysilane End Groups of Example 1

An adhesive composition comprising 0.2% by weight of a cross-linking catalyst constituted by dioctyltin dineodecanoate (product Tib kat 223 from the company Tib Chemicals), and the polymer according to the invention obtained in Example 1, is produced by mixing.

The mixture thus obtained was left under reduced stirring (20 mbar i.e. 2000 Pa) for 15 minutes before the composition thus obtained was packaged in an aluminium cartridge.

The strength and elongation at break were measured by tensile testing according to the protocol described below.

The measurement principle consists of stretching, in a tensile testing machine the movable jaw of which moves at a constant speed equal to 100 mm/min, a standard test piece constituted by the cross-linked adhesive composition, and recording, at the moment when the test piece breaks, the tensile stress applied (in MPa) as well as the elongation of the test piece (in %).

The standard test piece is in the form of a dumbbell, as illustrated in international standard ISO 37. The narrow part of the dumbbell used has a length of 20 mm, a width of 4 mm and a thickness of 500 μm.

In order to prepare the dumbbell, the composition packaged as described previously was heated to 100° C., followed by the extrusion onto an A4 sheet of siliconized paper, of the quantity necessary to form thereon a film having a thickness of 300 μm which was left for 7 days at 23° C. and 50% relative humidity for cross-linking. The dumbbell is then obtained by simple cutting out from the cross-linked film.

The dumbbell of the adhesive composition then has a breaking stress of 8 MPa with an elongation at break of 10%. This test is repeated twice and gives the same result.

The adhesive composition was then subjected to tests of bonding two wooden slats (each with a size of 20 mm×20 mm×2 mm) in order to lead, after cross-linking for seven days at 23° C., to a force at break of 2 MPa in adhesive rupture.

1. Hydrocarbon-containing polymer comprising two alkoxysilane end groups, said hydrocarbon-containing polymer being of formula (1) below: 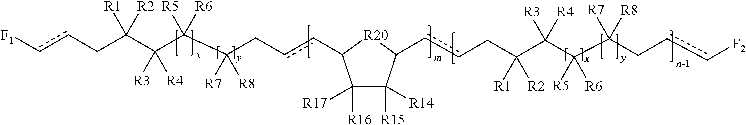
in which F₁ is (R′O)_{3-z}R_{z}Si—(CH₂)ₚ₁— and F₂ is —(CH₂)_{q1}—SiR_{z}(OR′)_{3-z}; or F₁ is (R′O)_{3-z}R_{z}Si—R″—OOC—(CH₂)ₚ₂— and F₂ is —(CH₂)_{q2}—COO—R″—SiR_{z}(OR′)_{3-z}; where z is an integer equal to 0, 1, 2 or 3; p1 and q1 are independently an integer equal to 1, 2 or 3; p2 and q2 are independently an integer equal to 0, 1, 2 or 3; the R and R′ groups are independently an alkyl group, preferably linear, comprising from 1 to 4, preferably from 1 to 2, carbon atoms; the R″ group is an alkylene group, preferably linear, comprising from 1 to 4 carbon atoms; and in which:
each carbon-carbon bond of the chain denoted [symbol] is a double bond or a single bond, in accordance with the valency rules of organic chemistry;
the R1, R2, R3, R4, R5, R6, R7 and R8 groups are independently a hydrogen, a halogen atom, an alkyl group, a heteroalkyl group, an alkenyl group, an alkoxycarbonyl group or a heteroalkoxycarbonyl group, at least one of the R1 to R8 groups being able to form part of the same ring or heterocycle, saturated or unsaturated, with at least one other of the R1 to R8 groups, according to the valency rules of organic chemistry and at least one of the (R1,R2), (R3,R4), (R5,R6) and (R7,R8) pairs being able to be an oxo group;
x and y are integers independently comprised in a range from 0 to 5, preferably from 0 to 2, even more preferably x is equal to 1 and y is equal to 1, the sum of x+y being preferably comprised in a range from 0 to 4 and even more preferably from 0 to 2;
the R14, R15, R16 and R17 groups are independently a hydrogen, a halogen atom, an alkyl group, a heteroalkyl group, an alkenyl group, an alkoxycarbonyl group or a heteroalkoxycarbonyl group, at least one of the R14 to R17 groups being able to form part of the same ring or heterocycle, saturated or unsaturated, with at least one other of the R14 to R17 groups, according to the valency rules of organic chemistry;
the R20 group is CH₂, O, S, NR₀ or C(═O), R₀ being an alkyl group or an alkenyl group, preferably linear, comprising from 1 to 22, preferably from 1 to 14, carbon atoms; and
n is an integer greater than or equal to 2 and m is an integer strictly greater than 0, the molar ratio m:n being comprised between 0 and 0.5, preferably between 0.25 and 0.5; n and m being moreover such that the number-average molecular weight Mn of the hydrocarbon-containing polymer of formula (1) is comprised in a range from 400 to 50,000 g/mol, preferably from 600 to 20,000 g/mol, and the polydispersity index (PDI) of the hydrocarbon-containing polymer of formula (1) is comprised in a range from 1.0 to 3.0, preferably from 1.0 to 2.0, even more preferably from 1.45 and 1.85.

2. Hydrocarbon-containing polymer comprising two alkoxysilane end groups according to claim 1, in which the polymer is of formula (1′) below: 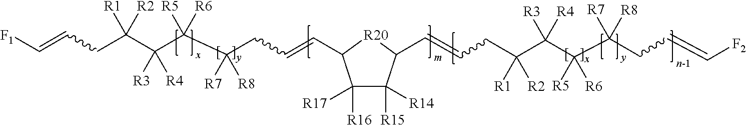
in which x, y, m, n, F₁, F₂, R1, R2, R3, R4, R5, R6, R7, R8, R14, R15, R16, R17 and R20 have the meanings given in claim 1 and the [symbol] bond is a geometrically oriented bond on either side with respect to the double bond (cis or trans).

3. Hydrocarbon-containing polymer comprising two alkoxysilane end groups according to claim 1, in which the polymer is of formula (1H) below: 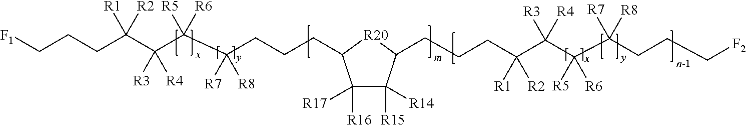
in which x, y, m, n, F₁, F₂, R1, R2, R3, R4, R5, R6, R7, R8, R14, R15, R16, R17 and R20 have the meanings given in claim 1:

4. Hydrocarbon-containing polymer comprising two alkoxysilane end groups according to claim 1, in which F1 is (R′O)_{3-z}R_{z}Si—(CH₂)ₚ₁— and F2 is —(CH₂)_{q1}—SiR_{z}(OR′)_{3-z}, with p1=1 or q1=1, preferably p1=q1=1.

5. Hydrocarbon-containing polymer comprising two alkoxysilane end groups according to claim 4, in which R′ is a methyl, z=0, p1=1 and q1=1.

6. Hydrocarbon-containing polymer comprising two alkoxysilane end groups according to claim 1, in which F1 is (R′O)_{3-z}R_{z}Si—R″—OOC—(CH₂)ₚ₂— and F₂ is —(CH₂)_{q2}—COO—R″—SiR_{z}(OR′)_{3-z}, with p2=0 or q2=0, preferably p2=q2=0.

7. Hydrocarbon-containing polymer comprising two alkoxysilane end groups according to claim 6, in which R′ is a methyl, R″ is the —(CH₂)₃— group, z=0, p2=0 and q2=0.

8. Process for the preparation of at least one hydrocarbon-containing polymer comprising two alkoxysilane end groups according to claim 1, said process comprising at least one ring-opening metathesis polymerization step, in the presence of:
at least one metathesis catalyst, preferably a catalyst comprising ruthenium, even more preferably a Grubbs' catalyst;
at least one difunctional alkoxysilane chain transfer agent (CTA) of formula (C) below: 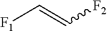
in which the bond [symbol] is a geometrically oriented bond on either side with respect to the double bond (cis or trans); F₁ is (R′O)_{3-z}R_{z}Si—(CH₂)ₚ₁— and F₂ is —(CH₂)_{q1}—SiR_{z}(OR′)_{3-z}; or F₁ is (R′O)_{3-z}R_{z}Si—R″—OOC—(CH₂)ₚ₂— and F₂ is —(CH₂)_{q2}— COO—R″—SiR_{z}(OR′)_{3-z}; where z is an integer equal to 0, 1, 2 or 3; p1 and q1 are independently an integer equal to 1, 2 or 3; p2 and q2 are independently an integer equal to 0, 1, 2 or 3; the R and R′ groups are independently an alkyl group, preferably linear, comprising from 1 to 4, preferably from 1 to 2, carbon atoms; the R″ group is an alkylene group, preferably linear, comprising from 1 to 4 carbon atoms;
at least one compound of formula (A) below: 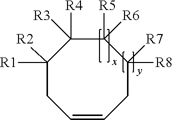
in which:
the R1, R2, R3, R4, R5, R6, R7 and R8 groups are independently a hydrogen, a halogen atom, an alkyl group, a heteroalkyl group, an alkenyl group, an alkoxycarbonyl group or a heteroalkoxycarbonyl group, at least one of the R1 to R8 groups being able to form part of the same ring or heterocycle, saturated or unsaturated, with at least one other of the R1 to R8 groups according to the valency rules of organic chemistry and at least one of the (R1,R2), (R3,R4), (R5,R6) and (R7,R8) pairs being able to be an oxo group;
x and y are integers independently comprised in a range from 0 to 5, preferably from 0 to 2, even more preferably x is equal to 1 and y is equal to 1, the sum of x+y being preferably comprised in a range from 0 to 4 and even more preferably from 0 to 2; and
at least one compound of formula (B): 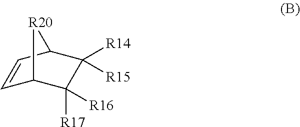
in which
the R14, R15, R16 and R17 groups are independently a hydrogen, a halogen atom, an alkyl group, a heteroalkyl group, an alkenyl group, an alkoxycarbonyl group or a heteroalkoxycarbonyl group, at least one of the R14 to R17 groups being able to form part of the same ring or heterocycle, saturated or unsaturated, with at least one other of the R14 to R17 groups, according to the valency rules of organic chemistry; and
the R20 group is CH₂, O, S, NR₀ or C(═O), R₀ being an alkyl group or an alkenyl group, preferably linear, comprising from 1 to 22, preferably from 1 to 14, carbon atoms; for a reaction time ranging from 2 to 24 hours and at a temperature comprised in a range from 20 to 60° C.

9. Preparation process according to claim 8, said process being such that the molar ratio of the CTA to the sum of the compounds of formulae (A) and (B) is comprised in a range from 0.01 to 0.10, preferably from 0.05 to 0.10.

10. Preparation process according to claim 8, said process being such that the CTA is selected from the group formed by the compounds of formula (C1) below: 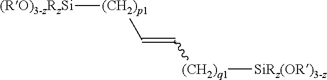
in which z, R, R′, p1, q1 and [symbol] have the meanings given in claim 8 and the compounds of formula (C2) below: 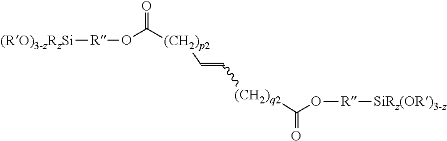
in which z, R, R′, R″, p2, q2 and [symbol] have the meanings given in claim 8.

11. Preparation process according to claim 8, said process being such that the CTA is selected from the group formed by bis(propyltrimethoxysilyl)fumarate and trans-1,4-bis(trimethoxysilyl)but-2-ene.

12. Preparation process according to claim 8, said process moreover comprising at least one additional step of hydrogenation of double bonds.

13. Preparation process according to claim 12, such that the additional hydrogenation step is implemented by catalytic hydrogenation, under hydrogen pressure and in the presence of a hydrogenation catalyst such as a carbon-supported palladium catalyst (Pd/C).

14. Adhesive composition comprising at least one polymer according to claim 1 and from 0.01 to 3% by weight at least one cross-linking catalyst, with respect to the weight of the adhesive composition.

15. Process of bonding by assembling two substrates comprising:
coating with an adhesive composition according to claim 14, in liquid form, preferably in the form of a layer with a thickness comprised in a range from 0.3 to 5 mm, preferably from 1 to 3 mm, over at least one of the two surfaces which belong respectively to the two substrates to be assembled, and which are intended to be brought into contact with each other at a tangency surface; then
effectively bringing the two substrates into contact at their tangency surface.
